(19) United States
(12) Patent Application Publication
(10) Pub. No.: US 2015/0220161 A1
(43) Pub. Date: Aug. 6, 2015

(54) Adapted back-side keyboard

(71) Applicant: Oleg Ryabchenko, Bataysk (RU)

(72) Inventor: Oleg Ryabchenko, Bataysk (RU)

(21) Appl. No.: 14/173,041

(22) Filed: Feb. 5, 2014

(51) Int. Cl. G06F 3/02

(52) U.S. Cl. CPC G06F 3/0216

(57) ABSTRACT

A removable or embedded back-side keyboard (hereinafter “keyboard”) for tablet computers and other transportable electronic devices (hereinafter “TD” or “tablet device”) is disclosed. The keyboard buttons are located on the back side of the TD, invisible for a user, in order to input information by fingers of both hands simultaneously when a user holds the keyboard in his/her hands without additional support. The device allows for a significantly increased speed of data input in the TD in comparison with other existing methods of information input, due to consideration of the anatomical structure of human hands and maximally facilitating adaptation to touch-typing, when a user doesn't see the keys.

### CROSS-REFERENCE TO RELATED APPLICATIONS

This patent application claims priority to, and incorporates fully by reference, U.S. Patent Application No. 61/761,172, filed Feb. 5, 2013.

### FIELD OF THE INVENTION

This invention relates to means of data input, applicable to personal tablet-type laptops, as well as cell phones, communicators, mono-blocks, game consoles, TV-sets, control panels, and other devices, in which an operator needs to input data manually. The invention can be used for inputting data in a TD by all fingers when the user holds the device in his hands.

### BACKGROUND OF THE INVENTION

Pull-out and connected keyboards for TDs are not suitable for use without additional supports. The full-fledged typing by all fingers on these keyboards is only possible on a desktop, which significantly reduces the possibility of full use of a tablet device. In this situation the user would like to use a laptop, as it has a larger screen.

Touch keyboards on a Tablet PC (sometimes divided into two parts, in order that input would be executed by the thumbs of both hands, holding a tablet device) is also a well-known solution. Then typing speed can be higher than typing by one hand—the way which is the most common now. But the level of input efficiency by all fingers, in this way, is almost out of reach.

A “chordal” method, disclosed in U.S. Patent Publications 2010/0109915 A1 and 2007/0247337 A1, is a method to input data when a user presses two button keys simultaneously to type a single character, and it is a good way to combine a compact keyboard and its reverse position, but only for small text typing. The difference becomes more and more noticeable when a user presses additional buttons during the typing of large texts. Additionally, the mastering of this keyboard demands additional efforts for those who have learned the QWERTY keyboard because it has a different principle of operation.

U.S. Pat. Nos. 6,107,988, 2008/0246731 A1, 2010/0109915 A1, 2004/0208681, 2007/0247337 A1, and 2012/0039021 A1, also offer a reverse layout of the keyboard on the back of the TD, with the projection of the button keys on the screen. They have not, however, adapted the keyboard to the position where the touch-typing is performed without visual control of the fingers.

Touch control, disclosed in U.S. Patent Publication 2004/0208681, is good to use in training to type on this keyboard, but after constant use, it will lead to an abundance of useless information on the screen. The keyboard navigating can be fully tactile with the help of solutions disclosed by the present invention.

All previously disclosed devices do not consider the structural features of human hands. Only U.S. Patent Publication 2012/0075125 A1 takes into account the different length of fingers but, again, does not describe a feedback mechanism interacting with the keyboard without visual control.

### SUMMARY OF THE INVENTION

Disclosed herein is a keyboard for data input on a mobile phone, tablet computer, or similar device. The keyboard, located on the reverse side of a given device, need not be seen in order to allow user control and data input. The keyboard can be embedded on or detachable from the user device and is made of four or less rows containing individual keys. The rows of keys are adjustable for different hand sizes and also contain special markers that can be felt by the fingers to signal different keys and locations on the keyboard, thus removing the requirement of having a visual of a keyboard on the actual screen of a user's device. Each key can correspond to an individual datum input or, alternatively, can comprise a multi-functional button with several different sensors and contact zones for the input of various data by pressing different areas of a button or moving the button along the surface of a device, thus eliminating the need for several more buttons. Particular versions may also include buttons, displays, and sensory areas on the front-side of a user device.

### BRIEF DESCRIPTION OF THE DRAWINGS

FIG. 1a—shows the back-side keyboard, built in the rear of the tablet device.

FIG. 1b—shows the back-side keyboard, connected to the TD, at the rear.

FIG. 1c—shows the back-side keyboard, built into the front of the TD casing.

FIG. 1d—shows the back-side keyboard, built in the rear of the TD casing.

FIG. 1e—shows the back-side keyboard, connected to the TD, from the front.

FIG. 2a—shows 2 blocks of keys of the back-side keyboard.

FIG. 2b—shows the location of hands on the back-side keyboard.

FIG. 2c—shows the location of key rows in the block of the back-side keyboard.

FIG. 2d—shows the location of the additional row of keys similar to qwerty-layout.

FIG. 3a—shows an example of the movable key block for individual position setting of the keyboard.

FIG. 3b—shows different slopes of the key rows to the horizontal axis of the TD, and shows the placement of key rows at different distances from the side faces of the device.

FIG. 3c—shows the moving rows of keys.

FIG. 3d—shows the area of additional keys or key rows position.

FIG. 4—shows (cross-sectional view) an example of holes and bumps on the keys.

FIG. 5a—shows (cross-sectional view) the keys of the keyboard, pressed down into the TD body.

FIG. 5b—shows (cross-sectional view) the keys of the keyboard, I pressed diagonally down into the TD body.

FIG. 5c—shows (cross-sectional view) the keys of the keyboard, pressed to the sides.

FIG. 6a—shows the version of the back-side keyboard, where the central buttons in each row are doubled.

FIG. 6b—shows a sectional view of a keyboard, where the central buttons in each row are doubled and moved to the sides.

FIG. 6c—shows a version of the back-side keyboard, where the keys in each row are connected in pairs.

FIG. 6d—shows a sectional view of a keyboard, where the keys in each row are doubled and moved to the sides.

FIG. 6e—shows the option of using 4-contact-point multi-buttons for each row.

FIG. 6f—shows a sectional view of the keyboard, where a 4-contact-point multi-button is used for each row.

FIG. 6g—shows the version of the 4-contact-point multi-button with a mobile central part in each row.

FIG. 6h—shows a sectional view of the keyboard, where 4-contact-point multi-button with a mobile central part is used for each row.

FIG. 6i—shows an example of a keyboard layout with 3-point (i.e. 3-directional) multi-buttons.

FIG. 6j—shows a cross-sectional view and the sensor/point locations of a 3-point multi-button.

FIG. 6k—shows a QWERTY layout scheme for a reverse side keyboard.

FIG. 7—shows a sectional view of a 5-contact-point multi-button.

FIG. 8a—shows an example of active keys layout for “chord” character input by simultaneous double clicking.

FIG. 8b—shows an example of doubled active keys for “chord” character input by simultaneous double clicking.

FIG. 9a—shows an example of a “chord” type keyboard with two keys for each finger and simultaneous clicking for the characters input.

FIG. 9b—shows an example of a “chord” type keyboard with the doubled key for each finger and with simultaneous clicking for the characters input.

FIG. 10—shows the scheme of a “chord” type keyboard with the function of simultaneous clicking for the characters input.

FIG. 11—shows an example keyboard with sensory multi-key.

FIG. 11a—shows a scheme of sensory multi-key.

FIG. 11b—shows a layout of the contact zones and sensors in 3-zone multi-key.

FIG. 11c—shows a layout of the contact zones and sensors in the 2-zone multi-key.

FIG. 12—shows an example of the sensor keyboard with relief surface contact zones.

FIG. 12a—shows a section of the touch keyboard embossed.

FIG. 13a—shows an example of block sensor keys with separation marker roughness between the contact zones, and the sensors underneath.

FIG. 13b—shows an example of block sensor keys with marker roughness on the contact zones.

FIG. 13c—shows an example of block sensor keys, combined with separation marker relief between 2 contact zones.

FIG. 14—shows an example of a keyboard with mixed type.

FIG. 14a—shows a structure of mixed type keys.

FIG. 15—shows the TD front with the layout options of service keys and the keyboard projection on screen.

FIG. 16—shows the retaining straps for hands.

FIG. 17—shows examples of the variants of key tilt.

FIG. 18—shows examples of the variants of TD surface tilt.

FIG. 19—shows examples of key marker signs.

FIG. 20—shows examples of different forms of keys.

FIG. 21—shows examples of the variants of the arrangement of key markers.

### REFERENCE NUMERALS

(please note that some of the terms below are used interchangeably, meaning the same, throughout this disclosure):
11 Tablet Device
12 Body of Tablet Device
14 Touch screen of Tablet Device
16 Block of the main keys for the left hand (i.e. key block)
18 Block of the main keys for the right hand (i.e. key block)
20 Row of keys for the Index finger
22 Row of keys for the Middle finger
24 Row of keys for the Ring finger
26 Row of keys for the Pinky
28 Additional row of keys
30 Tactile Marker/Marker Sign
32 Example of a removable back-side keyboard
34 Back-side keyboard built into the case for a tablet device
36 Top additional keys
37 Side additional keys
38 Sensors
40 Additional keys for thumb
42 Touch keys (i.e. sensor keys on screen, buttons on front part of a consumer device)
44 Touch-pad (i.e. sensor) area for cursor control
46 Projection of keyboard on screen
48 Movable key block
50 Movable rows of keys
51 Concave keys
52 Area for additional keys and additional rows of keys
53 Convex key
54 Plane of keys layout
56 Side keys in a row
58 Central key in a row
60 Tactile Marker in the form of space between keys
62 Keys
64 Key with the direction of pressing diagonally
66 Dual mobile key (multi-functional key example)
68 Additional row of keys
70 Plane of key layout
72 Keys with an inclined surface
74 Strap
76 Additional pushbutton (i.e. center area button) on a multi-button
78 Active keys for “chord” input method
80 Active dual (i.e. multi-functional) keys for “chord” input method
82 Keys of condensed, “chord” keyboard simultaneously pressing
86 Sensory multi-key (multi-functional key example)
88 Contact zone of a data/symbol input by pressing down/inward
90 Contact zone of a data/symbol input by longitudinal movement (left/right)
92 Sensors (one for each contact zone)
94 Tactile Marker (relief)
95 Separating marker roughness (tactile marker example)
96 Marker space (tactile marker example)
98 Touch-sensitive surface element of key
99 Mixed type multi-key (multi-functional key example)
100 Sensors (for contact zones)
101 3-Point multi-key (multi-functional key example)

### DETAILED DESCRIPTION OF THE PREFERRED EMBODIMENT

It is common knowledge that in modern devices, the most comfortable area for pressing the button keys, and hence for the key layout, is rather small compared to hand size.

The present invention takes into account that the most anatomical keystroke is not pushing down, but rather pressing diagonally or to the side when the user holds the TD in his/her hands.

The reverse keyboard disclosed herein is easy to use, compact, offers feedback to the user on a tactile level, and considers the physiological structure of the human hands.

Each row can contain from 3 to 5 button keys depending on the number of the most commonly used characters and design of the device.

Button key blocks may be mobile for easy configuration of their position (FIG. 3a).

Rows of button keys can be arranged at an angle to the horizontal axis of the TD. This angle may be different relative to each row (FIG. 3b).

It is optimal but not necessary to arrange rows of button keys for each finger at different distances from the side of the TD, according to the anatomical structure of the hand (FIG. 3b). If the rows of button keys are integrated into the mobile unit, the distance may be adjustable (FIG. 3c). Also, each key can be adjusted based on individual finger size and length. The keys can be moved, using almost any mechanical method, in a lateral direction (i.e. up, down), a horizontal direction (i.e. left, right), and in a diagonal direction, allowing for each individual user to slightly change the button layout to best fit their hands. Examples of mechanisms for adjusting include, but are not limited to, a sliding and locking mechanism, a clicking and step mechanism, and a spinning mechanism.

Additional rows of button keys and some additional button keys can be located close to the main rows, but in a way that would not interfere with the main rows of button keys (FIG. 3d).

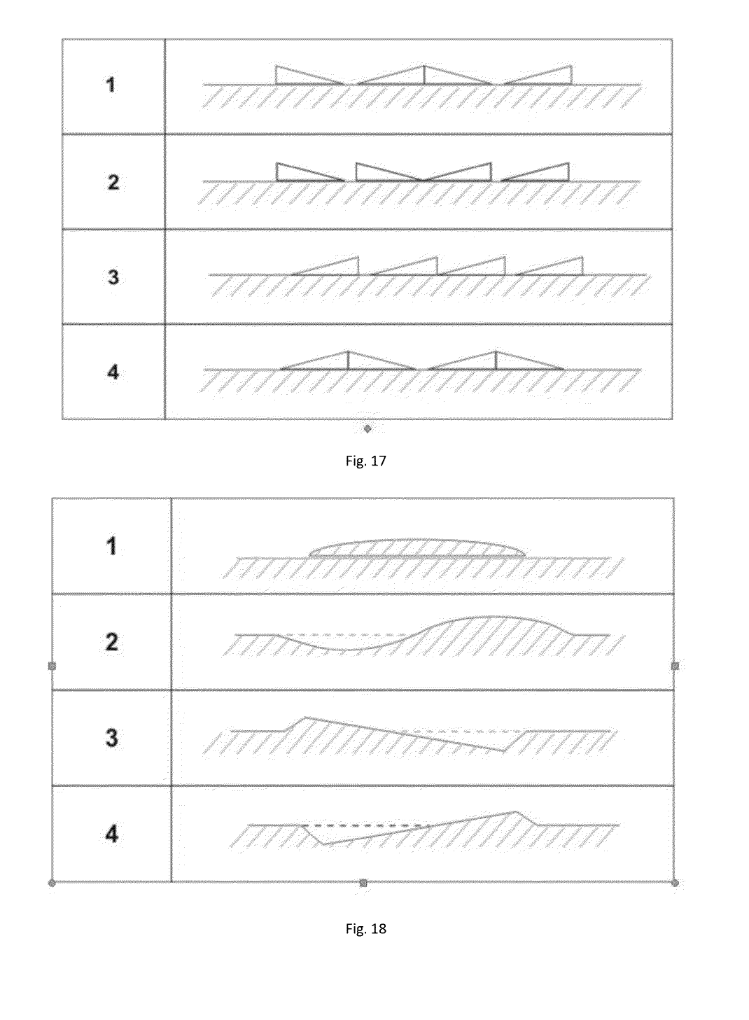

Surfaces of the button keys (FIG. 17), as well as the plane of their placement (FIG. 18) can be curved or angled to the surface casing or TD for the most anatomical pressing.

To ease data entry operation without eye contact with the keyboard, the button keys, located in the middle of each row, can have tactile markers, thus making these buttons marker signs for non-visual determination (30). The user can easily navigate with the help of this feature and feel what button keys he pushes and what button keys without tactile markers are arranged nearby.

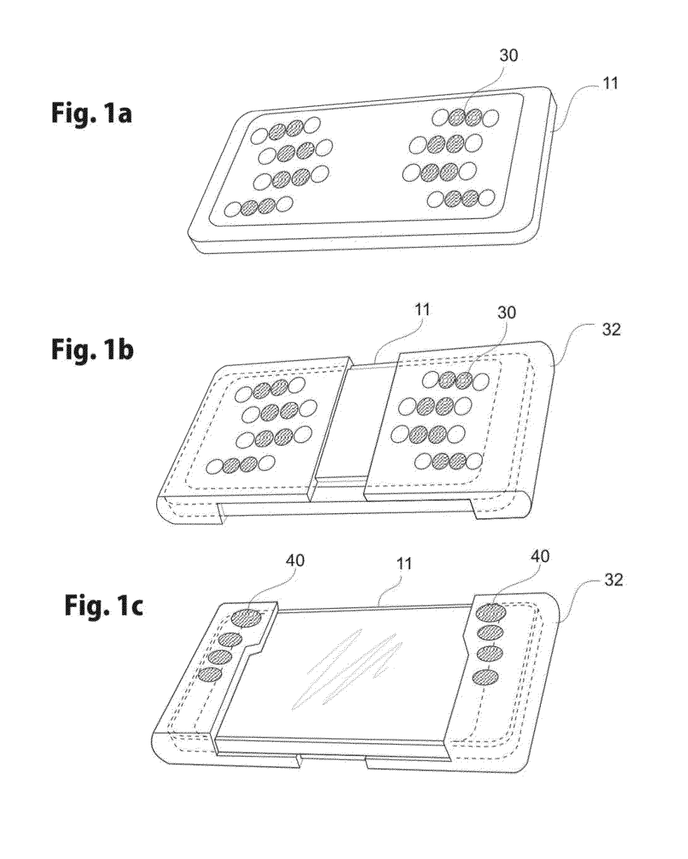

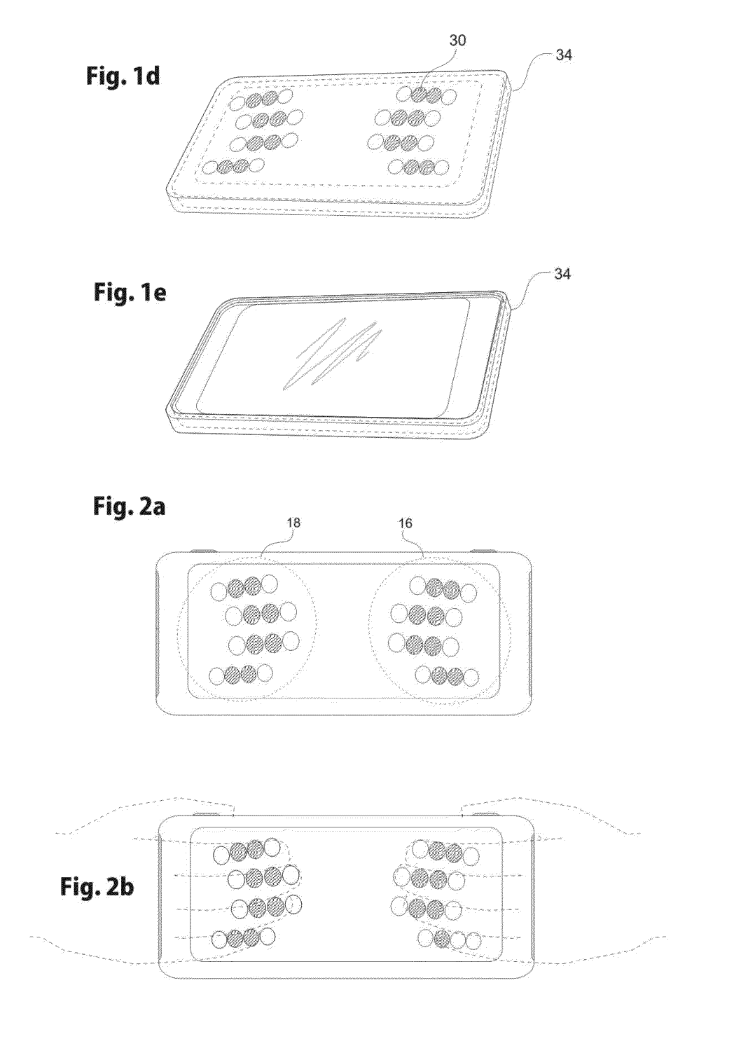

The keyboard consists of two block keys, accordingly for right (18) and left hand (16), located on the back side of the TD (11) as a built-in element (FIG. 1a), as an attached device (FIG. 1b), or as a part of a protective cover (FIG. 1c).

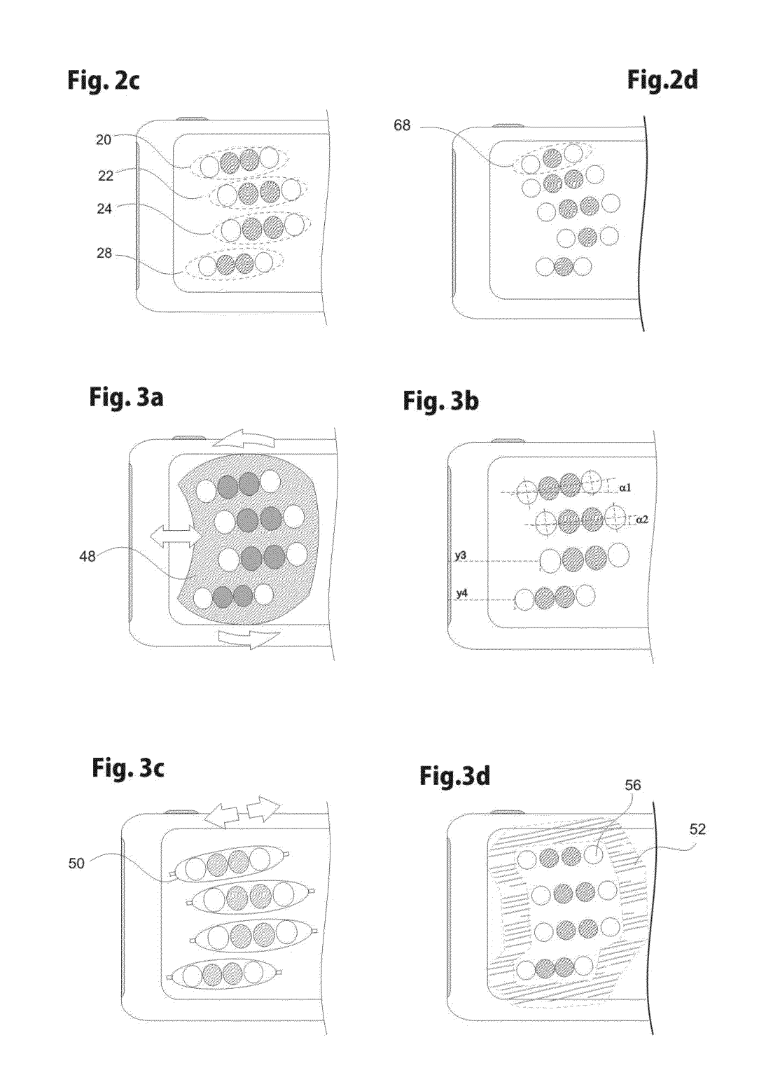

In each block, the keys are arranged in horizontal rows (FIG. 2a: 16, 18), so that when the user holds the TD in his/her hands at the sides, each of these rows would coincide with the location of the respective finger and with the amplitude of its motion. The rows of button keys (20-28) are placed in such a way that the fingers in a relaxed position are located above the center button key in the appropriate row, and could easily reach any button in the row.

Each block of keys (FIG. 2c: 16, 18) contains 4 main rows of button keys.

An authentic QWERTY layout will require 5 rows at least (FIG. 2d). This is possible, but the optimal number in terms of ergonomics is 4 rows in the block. One key row is for one finger in order that the arm would not move along the vertical axis of the device during data entry operation. One solution to this problem is the placement of two multi-functional buttons, or keys, for use by the index finger. All other finger excluding the thumb (i.e. middle, ring, and pinky fingers), however, will only use one multi-functional button, or key. Thus, each key block will comprises 5 total buttons, with an additional button for use by the index finger. Such a layout for each key block, located on each side of a consumer device, allows for compatibility with a QWERTY scheme.

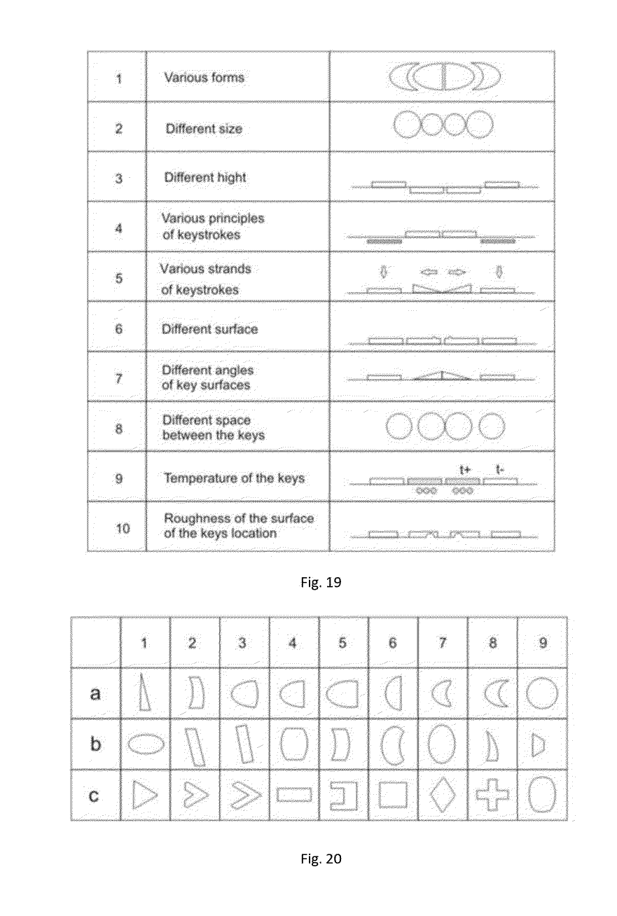

Examples of variations in key marker signs are shown in FIG. 19.

Examples of various forms of the button keys are shown in FIG. 20.

Variations include, but are not limited to, the following:

Different sizes of the button keys.

Different depth/elevation and height of the keys relative to the surface on which they are located.

Various principles of pushing the button keys, such as sensorial or mechanical.

Various directions of keystrokes, for example—pressing down or aside.

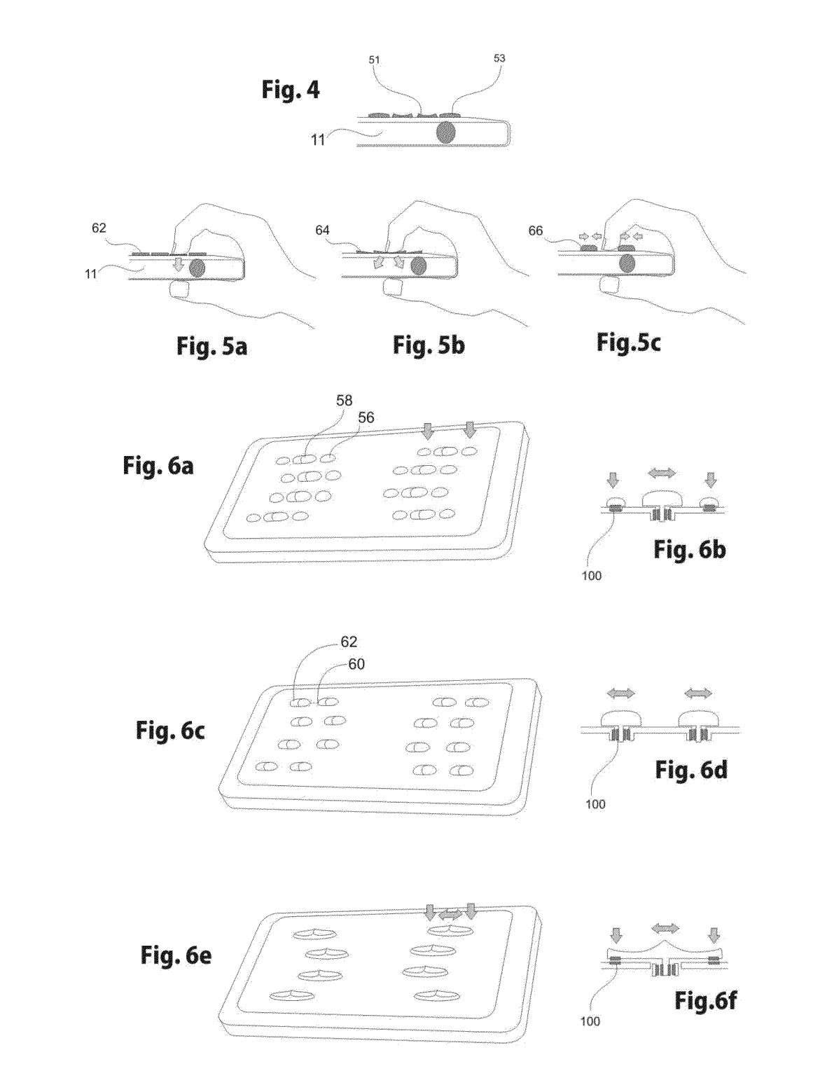

Different surfaces of the keys (See FIG. 4) made of a different material or key relief.

Different angles of keys.

Different space between the keys—marker keys may be located closer, or vice versa, i.e. further apart, than the other keys; they can be joined together into one block, or vice versa, i.e. separated, in contrast to the other keys.

The temperature of the keys—if there are heating elements under or inside of them or, vice versa, no heating elements.

The roughness of the surface on which the button keys are located; can also be marker signs that indicate the location of the marker keys.

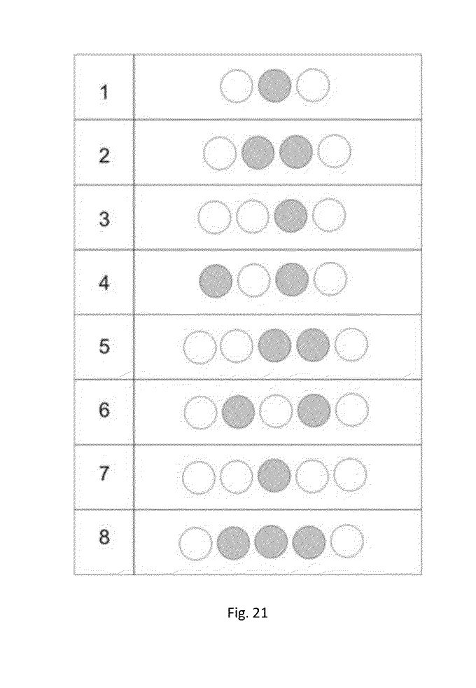

Depending on the total number of button keys in a row, and the requirements of ergonomics and design, the number of keys that have marker signs can vary from 1 to 3 (FIG. 21). Also, marker button keys can be placed alternately with conventional, non-marker button keys in each row.

If the marker button keys are two or three, they may be different from each other by the different characteristics of the marker signs. (FIG. 19: Examples 1, 5, 6, 7)

The marker button keys can have more marker features simultaneously for the best tactile orientation.

Very important and effective marker signs are button key relief and button key differences in the direction of pressing because of the anatomical structure of the hand muscles. The most convenient direction of back-side keyboard keystrokes is not deep inside strictly (FIG. 5a), but deep into the body diagonally (FIG. 5b), to the side (FIG. 5c), or along the horizontal axis of a TD body.

The combination of these features allows a user to focus on the keyboard very well, even blindly.

The button keys, which are pressed deep into the body, are also applicable in the back-side keyboard but require a longer period of use and extra effort in training.

The most preferred combinations of marker signs are:

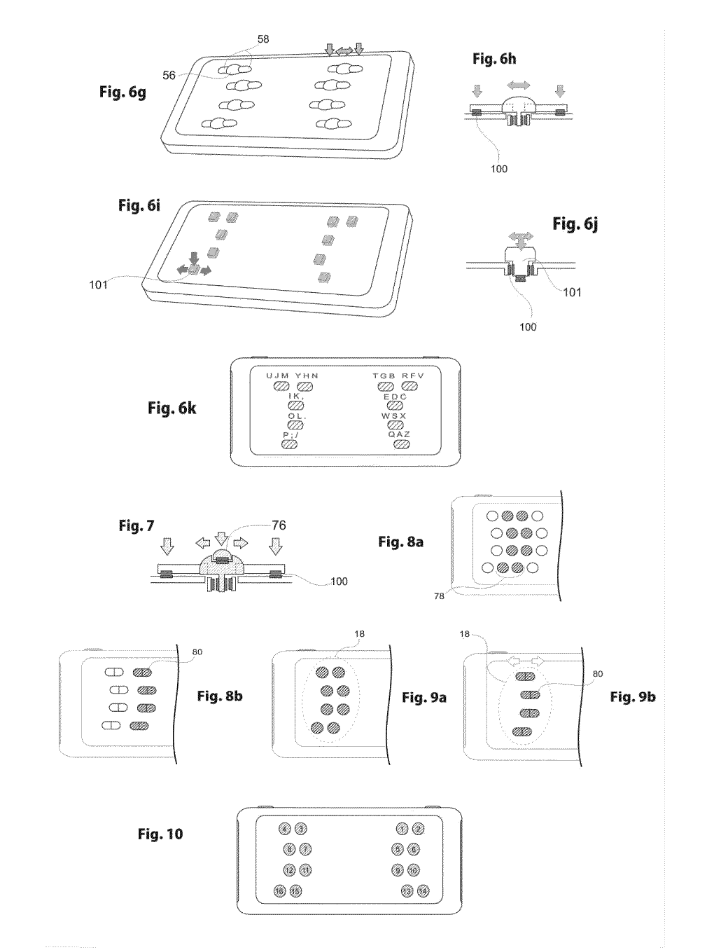

Two central marker buttons in each row are dual, have a different angle compared to the surface (FIG. 6a), and can be pressed to the sides, but not deep into the TD (FIG. 6e).

In each row, there are 4 keys that are connected in pairs (FIG. 6b). Marker sign is the space between pairs. When pressed, they can move in opposite directions along the horizontal TD axis (FIG. 6f).

For maximum compactness of the keyboard, each row is performed in the form of multi-buttons, each of which has 4 standard operating positions: pressing down on the edges, and moving to the side (FIGS. 6c, 6g).

Using a composite key that combines the mobile elements and elements for pressing also solves this problem. The side keys (FIG. 6d) in this block are pressed down and the central key (FIG. 6h) moves to the side.

For users who prefer or are most comfortable with QWERTY layouts (or similar layouts, which consist of approximately 30 characters), the optimal configuration of keys on the backside keyboard is a combination of 3-point (i.e. 3-directional, or a button with 3 different signal sensors based on different directional movement of the button; see FIG. 6j, for example) multi-buttons, or multi-keys, for each finger except the index finger, for which there are two 3-point multi-keys (FIG. 6i). This type of layout minimizes unnecessary movement of the fingers; except for the index finger, all other fingers are fixed to only one multi-button. A total of thirty (30) character units can be entered by using this type of keyboard layout, i.e. 30 characters per pair of blocks (FIG. 6k).

Condensed Versions of the Back-Side Keyboard

The keyboard can be switched to the “chordal” mode program according to a user's wish. It is necessary to press minimum two keys simultaneously to enter one symbol. The number of used keys in a row of keys for each hand is reduced twice. Two pairs of keys located in each row (FIG. 10a) or four doubled keys is enough (FIG. 10b).

The difference, from the disclosure offered in U.S. Patent Publication 2010/0109915 A1, is that additional keys (on obverse and sides of the TD) are not used to type main symbols, and it is necessary to press two keys to type one symbol always. It is a drawback on the one hand and an advantage on the other hand. The mastering of this keyboard is more simple for some users. This makes it possible to quickly use motor memory, because additional logical binarity is missing.

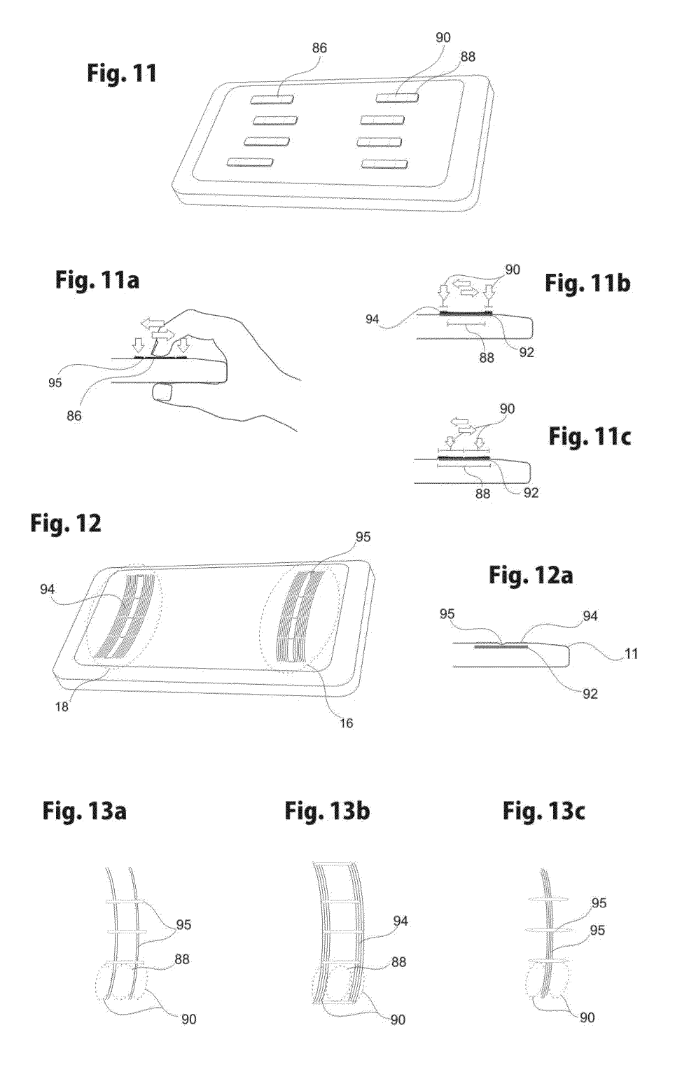

One symbol input is facilitated by two different key pressing in a reduced variant of the keyboard, where only one (FIG. 11a) or two (FIG. 11b) doubled keys in each row are used for one hand finger.

It is the optimal variant if the maximum speed of data entry is not critical, but the aesthetics and laconism of design is extremely important. In such case, for instance, it would be necessary to press keys 1 and 3 to enter character “A” and to press keys 1 and 4 to enter character “B”.

The space between keys in each row can be the marker sign to facilitate the usage of the keyboard without eye contact.

Visual simplicity of the keyboard, that will attract most buyers of the product, is the significant marketing advantage of this version. Also it won't create big problems to designers, when they will inscribe this element into the design of the product. Moreover, it is a good occasion to bring in new individual features.

The average data entry speed on this keyboard will concede to the best mode disclosed herein, because it is necessary to push once to enter one character, due to convenience key layout and minimize movement of fingers on the keyboard.

Sensory Versions of the Back-Side Keyboard

Use of touch surfaces that react to pressing and the longitudinal motion of the fingers, allows for the design of a keyboard most concise and compact. The convenience of such a keyboard will depend on many factors including, but not limited to: ergonomics and design of the keyboard and TD, the sensitivity of sensors, their settings, and a user's skills handling sensory devices.

In one particular embodiment of the present invention, a keyboard for each finger (FIG. 11), instead of containing several physical buttons, has one multi-touch (i.e. multi-functional) key (86). Each multi-touch key can have one, two, or three conditional contact zones, and each zone corresponds to a sensor (See FIGS. 11a, 11b, 11c). A block of keys, one for each hand (16, 18), contains 4 multi-keys.

If the multi-key has three contact zones, the average contact area on the surface (90) has a dual role: the movement of a finger to the left—a set of one character, the opposite movement—another. Clicking on the edge of the key, where the lateral sensory areas of the press (88), accordingly—the input of third and fourth of characters.

Additional possibilities arise if the sensor surface may differ a longitudinal movement of pressing. Then the touch key can be even more compact, and have only two contact zones, each corresponding to a sensor (FIGS. 11c, 12, 12a and 13c), where each of these areas separately responds to finger pressure, and together—they sense a longitudinal motion to the left and right.

To facilitate orientation without visual control, sensory contact zones (88, 90) may tactilely differ from the surface of the body of TD relief (94), or, conversely, its absence (FIGS. 13a, 13b), as well as other tactile marker signs as described and shown by the Figures herein.

Also, for exact keystrokes “in the blind”, marker roughness (95) or token space on the TD body can be very useful. They can share the different sensory areas of the keyboard.

The sensory contact surfaces need not be distinct from the body surface of the TD. In this case, there may be additional reference marker features—for example, roughness between sensory zones or physical buttons between them.

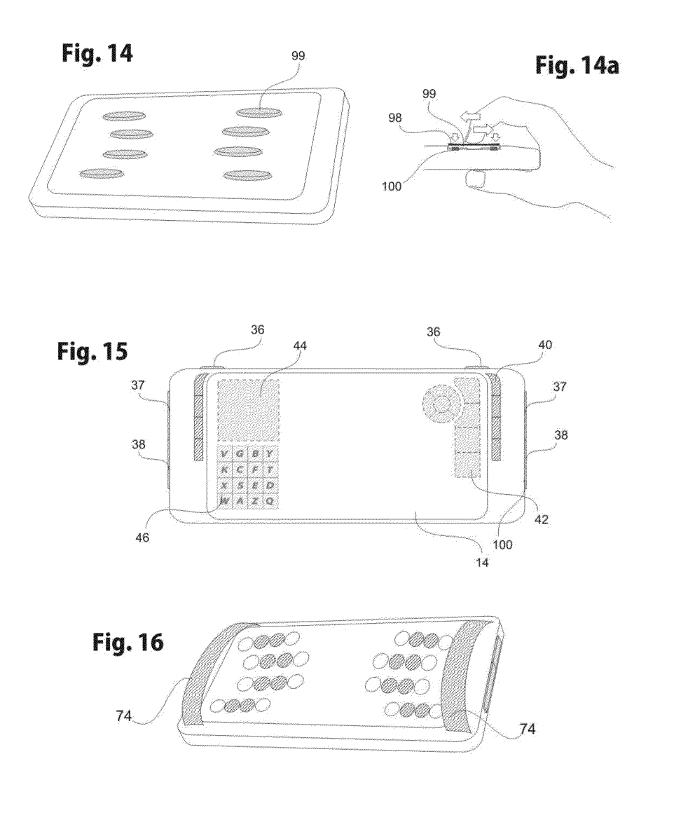

If the upper surface of the physical two-pin keys to equip the sensor (98) for sensing the longitudinal motion of the keys (from left to right and vice versa), the combination (FIGS. 14, 14a) of sensory effects and the physical principle of depression makes the keyboard the most tactilely convenient and compact.

Pressing a combined (composite) multi-key (99) from one side or the other signals the input of characters from a pair, and moving one's finger from left to right or vice versa signals the input of characters of the other pair (FIG. 14a).

Thus, a physical two-pole button layout, equipped with a sensor key for a 4-contact-point input, allows for combining the two principles and even the possibility of a random mix up the pressing of two characters and the longitudinal motion of the two adjacent zones to signal an additional input.

Additional Features

Service keys—switch layout keys, shift key, space, arrow keys and similar buttons can be located on the front of TD (FIG. 8) or keyboard (if it is attached separately). They can be both physical (40) and sensory (42). Then they are displayed on a ID screen with a special program, like other virtual keyboards. They are placed in a way that would make it convenient to press by thumbs.

Special areas, that will control the cursor (44) on the principle of a touch-pad, can also be arranged on the TD screen according to the user's and the manufacturer's request. They are placed in such a way that they would be pressed by thumbs.

Additional keys can also be arranged at the upper (36) and side end (37) faces of a device.

Keys or sensors (38) fixed to the device being used, can also be arranged in places of holding the device in one's hands.

The connection with a TD can be realized via a wired or wireless connection, if the keyboard is not built-in.

The layout of the main keyboard blocks may change and vary depending on the user's wishes on a software level.

Keys in the blocks can be projected on the TD programmatically (FIG. 15: 48), according to the desire of a user using known methods.

Movable marker keys can be equipped with additional pushbuttons (FIG. 7).

The keyboard may have straps or supporting bars (74) in order to hold the device with one hand (FIG. 16).

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “embodiment,” “example,” “exemplary,” etc., are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the teen “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A back-side keyboard for a smart phone, tablet computer, or similar consumer device, comprising:
at least two key blocks embedded on a reverse-side of the consumer device, one key block for a left human hand and one key block for a right human hand, wherein each key block comprises at most four (4) rows of keys for data input, the rows corresponding to individual fingers, excluding a thumb, of a human hand, wherein each row comprises at least one key, thus allowing for non-visual data input, wherein each row has a tactile marker located in a middle area of the row, wherein the tactile markers permit non-visual determination of a first set of keys of a row corresponding to a first set of data inputs and a second symmetrical set of keys of the same row corresponding to a second set of data inputs, and wherein the first set of keys is located to a left side of the tactile marker, and the second symmetrical set of keys is located to a right side of the tactile marker.

2. The keyboard according to claim 1, wherein the tactile marker is in a form of an additional space between keys, the additional space being greater than a space between other keys of the same row.

3. The keyboard according to claim 1, having two or more sub-keys combined together forming a multi-functional key with a shape different from a shape of other keys in the same row, the multi-functional key being the tactile marker, and the multi-functional key is used for input of at least two different data symbols.

4. The keyboard according to claim 3, wherein the multi-functional key is a button that has at least four functions which correspond to at least four different data inputs based on four or more of the following: pressing on a left side of the button, pressing on a right side of the button, a longitudinal movement to a right side, a longitudinal movement to a left side, and pressing on a center area of the button.

5. The keyboard according to claim 3, wherein each key further comprises one continuous unit with at least three sensors for at least three contact zones: a central zone, a left side zone, and a right side zone.

6. The keyboard according to claim 3, wherein each key further comprises one continuous unit with a touch-sensitive surface and at least four sensors for at least four contact zones: a left side zone, a right side zone, a zone for a longitudinal movement to a left side, and a zone for a longitudinal movement to a right side.

7. The keyboard according to claim 1, wherein a location of at least one key is adjustable laterally, horizontally, and diagonally according to a given user, based on a size of each finger.

8. The keyboard according to claim 1, further comprising at least one sensor key on a screen or a button on a front part of the consumer device.

9. The keyboard according to claim 1, further comprising at least one sensor area for cursor control on a screen of the consumer device.

10. The keyboard according to claim 1, wherein each key block comprises two or more tactile markers located (1) on each key, (2) between keys in each row of keys according to a principle of unity, (3) at a center area of each row, (4) on at least one key of each row, and (5) in a form of space or relief between keys.

11. The keyboard according to claim 10, wherein the tactile markers, corresponding to specific locations on a key block, comprise surfaces of the key block with at least two variations in: size, form, shape, height, depth, material, relief, grain, roughness, smoothness, temperature, angle, and inclination.

12. The keyboard according to claim 1, wherein each key further comprises at least two sensors for signaling at least two different inputs, the sensors being responsive to: pressing of different areas of a key, different angles of pressing a key, and different longitudinal movement of a key along a surface of a key block.

13. The keyboard according to claim 1, further comprising a projection of a key layout onto a screen of the consumer device during data input.

14. The keyboard according to claim 1, wherein at least one key block further comprises at least one additional row of keys comprising at least one key.

15. The keyboard according to claim 1, further comprising additional keys for a QWERTY-layout reproduction, wherein a key layout comprises one multi-functional key for each middle finger, ring finger, and pinky finger, and two-multifunctional keys for each index finger.

16. The keyboard according to claim 1, further comprising a cavity located on at least one key.

17. The keyboard according to claim 1, further comprising a convex surface on at least one key.

18. The keyboard of claim 1, wherein said keyboard comprises a unit detachable from the consumer device.

19. The keyboard according to claim 1, wherein data is input by pressing at least two keys simultaneously.

20. The keyboard according to claim 1, wherein a first key block differs from a second key block in a number of rows and a layout of keys, thus allowing for input of less commonly used data and symbols.
